(19) United States
(12) Patent Application Publication
(10) Pub. No.: US 2021/0019847 A1
(43) Pub. Date: Jan. 21, 2021

(54) SYSTEM AND METHOD FOR REPORTING HISTORICAL SEVERE WEATHER ACTIVITIES FOR A PROPERTY

(71) Applicant: Daron Sneed, Plano, TX (US)

(72) Inventor: Daron Sneed, Plano, TX (US)

(21) Appl. No.: 16/931,324

(22) Filed: Jul. 16, 2020

Related U.S. Application Data
(60) Provisional application No. 62/874,778, filed on Jul. 16, 2019.

(51) Int. Cl. G06Q 50/16; G06F 16/29; G06F 16/9537; G06K 19/06; G01W 1/00

(52) U.S. Cl. CPC G06Q 50/16; G06F 16/29; G01W 1/00; G06K 19/06037; G06F 16/9537

(57) ABSTRACT

An online method is used to acquire historical data for severe weather activities associated with a real property to analyze potential damages and risk level thereof. The method searches both internal and external databases to acquire and process historical data of severe weather activities in addition to various general property data including map data, demographic data, property listing data, property construction detailed data, etc. The acquired weather data for the specific property include at least one severe weather activity such as hail, high wind, lightning, etc., for a predetermined period of time. The method subsequently processes the severe weather data and conducts risk analysis for each of the severe weather activity. Further, the method provides the severe weather activity report to equip a potential buyer with pertinent knowledge of historical severe weather events.

The current application claims a priority to the U.S. Provisional Patent application Ser. No. 62/874,778 filed on Jul. 16, 2019.

### FIELD OF THE INVENTION

The present invention relates generally to data processing for real estate properties. More specifically, the present invention relates to a system and method for reporting historical severe weather activities associated with a real estate property and/or a building in an area around an exact address.

### BACKGROUND OF THE INVENTION

Severe weather damages to real estate properties have been monitored, recorded, and even modeled using various systems and methods for decades. In addition, multiple severity scoring/ranking systems for weather damage incurred to structures have been developed. Most of these damage data and severity scoring/ranking systems, however, have seldom been incorporated into real estate transactions in a systematic way to benefit buyers. In the real estate industry, for example, homes are purchased often with only the knowledge of prior damages from the previous owners and/or sellers and a professional home inspector, who looks for signs of damage to the homes when hired for the inspection service. These damaging events can lead to serious and potentially very expensive repairs or replacements. Due to the subtle signs of damage that may have happened, failure to identify damages is common. Sellers are not always at the residence when severe weather happens and may be unaware of activities that may have affected a home.

Thus, it is the objective of the present invention to provide a solution to the aforementioned drawbacks, problems, and issues. The present invention, an online system and method for acquiring and analyzing historical data of severe weather activities associated with a real property, offers critical information to a user, especially a potential buyer with pertinent knowledge of historical severe weather events.

### SUMMARY OF THE INVENTION

The present invention provides an online system and method to a user to acquire historical data for severe weather activities associated with any real property which can be any residential and/or commercial properties, buildings, land, etc. The method facilitates the severe weather data reporting through the user input of a physical property address or geographical coordinates. When an address is specified, the method converts the address into geographical coordinates, which are used in subsequent searches and report creation.

The method takes advantage of both internal and external databases to acquire and process historical data of severe weather activities in additional to various general property data including, but not limited to, map data, demographical data, property listing data, property construction detailed data, etc. Among the various databases, the method frequently utilizes the plurality of weather databases from the data servers of Dynamic Weather Solutions, Incorporated (DWS), which has been providing substantial severe weather data for over 10 years.

The acquired weather data for the specific property include at least one severe weather activity including, but not limited to, hail, high wind, lightning, etc., for a predetermined period of time, which may be specified by the user or by the method as a default value such as three-year, five-year, 10-year, etc. The method subsequently processes the severe weather data to generate a plurality of statistics including, but not limited to, dates and number of days of severe weather activities, largest hailstone size, highest wind speeds, number of lightning strikes, hail risk level, high wind risk level, lightning risk level, etc. Further, the method conducts risk analysis for each of the severe weather risk levels, estimates potential for property damages, and recommends risk mediation actions.

The method incorporates all property data acquired and processed by the present invention into a report. The property report is created in any suitable digital format including, but not limited to, digital portable format (Adobe® PDF), and made available to the user through electronic mail (email) deliver and notification for online download. Further, the method creates and can include a verification quick response (QR) code to the property report so that the property report can be securely verified. Thus, the data, especially, the severe weather activity data, in the property report provided by the present invention can equip a potential buyer with pertinent knowledge of historical severe weather events.

### BRIEF DESCRIPTION OF THE DRAWINGS

FIG. 1 is a block diagram illustrating the system overview of the present invention.

FIG. 2 is a flowchart for the overall process followed by the method of the present invention.

FIG. 3 is a flowchart for a sub-process for prompting a specific user to enter geographical coordinates of a specific property of the present invention.

FIG. 4 is a flowchart for a sub-process for converting a property address into geographical coordinates by the method of the present invention.

FIG. 5 is a flowchart for a sub-process for generating property location data by the method of the present invention.

FIG. 6 is a flowchart for an alternative embodiment of the sub-process for generating property location data by the method of the present invention.

FIG. 7 is a flowchart for a sub-process for generating property general data by the method of the present invention.

FIG. 8 is a flowchart for an alternative embodiment of the sub-process for generating property general data by the method of the present invention.

FIG. 9 is a flowchart for a sub-process for generating monthly outdoor temperature data for the specific property by the method of the present invention.

FIG. 10 is a flowchart for a sub-process for generating severe weather data by the method of the present invention, wherein severe weather data include hail activities.

FIG. 11 is a flowchart for an alternative embodiment of the sub-process for generating severe weather data by the method of the present invention, wherein severe weather data include high wind activities.

FIG. 12 is a flowchart for another embodiment of the sub-process for generating severe weather data by the method of the present invention, wherein severe weather data include lightning activities.

FIG. 13 is a flowchart for another embodiment of the sub-process for generating severe weather data by the method of the present invention, wherein severe weather data include hail risk analysis.

FIG. 14 is a flowchart for another embodiment of the sub-process for generating severe weather data by the method of the present invention, wherein severe weather data include high wind risk analysis.

FIG. 15 is a flowchart for another embodiment of the sub-process for generating severe weather data by the method of the present invention, wherein severe weather data include lightning risk analysis.

FIG. 16 is a flowchart for a sub-process for creating property report by the method of the present invention.

FIG. 17 is a flowchart for an alternative embodiment of the sub-process for creating property report by the method of the present invention, wherein a verification quick response (QR) code is created and attached to the report.

FIG. 18 is the first page of an exemplary property report created by the method of the present invention.

FIG. 19 is the second page of the exemplary property report created by the method of the present invention, wherein the severe weather activity data and the QR code are presented.

FIG. 20 is another exemplary property report created by the method of the present invention, wherein the severe weather activity data including risk analysis for hail and high winds are presented.

FIG. 21 is another exemplary property report created by the method of the present invention, wherein the severe weather activity data including risk analysis for lightning are presented.

### DETAIL DESCRIPTIONS OF THE INVENTION

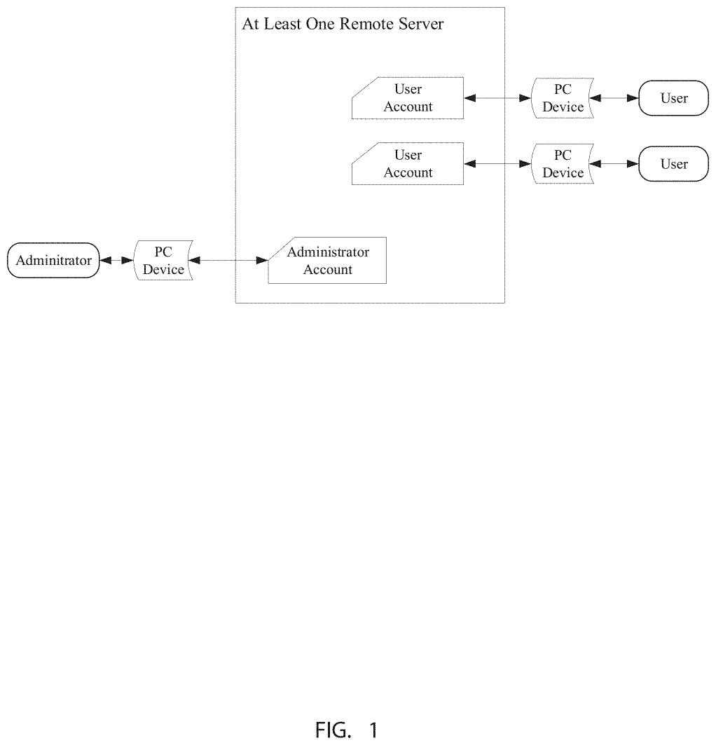

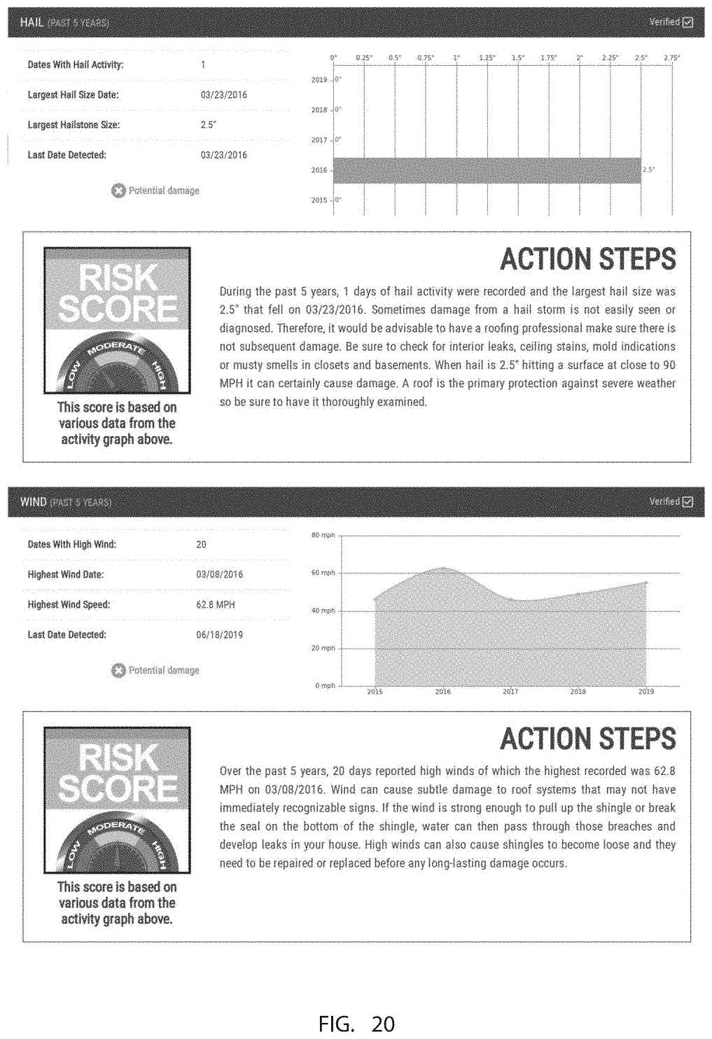

As can be seen in FIG. 1 to FIG. 21, the present invention is a system and method for reporting historical severe weather activities associated with a real estate property and/or a structure in an area, called “property” hereafter, around an exact location, in additional to information of various property details, characteristics, and area demographics. Such historical severe weather activities may include, but are not limited to, specific weather events for hail, high winds, lightning activities, etc., which may cause damages to and/or pose risks to the structures/materials of a specific property. The weather data for a specific property is acquired from the external and internal databases such as those from the data server of the Dynamic Weather Solutions, Incorporated (DWS). This data is used to determine if precautionary actions should be taken to ensure the property conditions that could have been affected by severe weather activities. The generated reports are made available to a user in an online web-based account and available in digital formats including, but not limited to, Adobe® PDF (portable digital format), or any other suitable format.

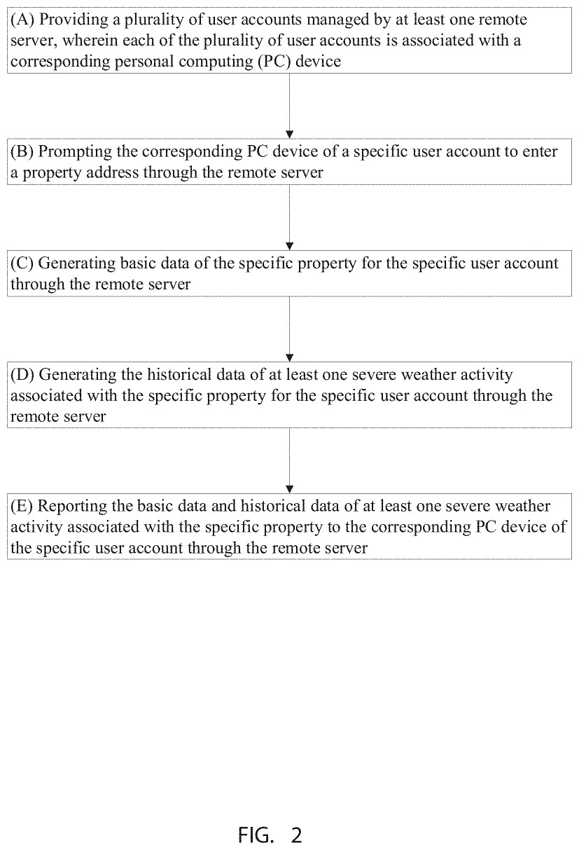

As can be seen in FIG. 1, the present invention provides an innovative system and method to report historical data of at least one severe weather activity associated with a property in additional to general demographic and construction data to a user. To accomplish this, the method of the present invention associates each of the plurality of users with a unique user account from a plurality of user accounts that are managed by at least one remote server (Step A), as seen in FIG. 2. Each of the plurality of user accounts is associated with a corresponding personal computing (PC) device. The corresponding PC device allows a user to interact with the present invention and can be, but is not limited to, a smartphone, a smart watch, a cloud PC, a laptop, a desktop, a server, a terminal PC, or a tablet PC, etc. The users of the user accounts may include relevant parties such as, but are not limited to, individuals, home buyers, real estate agents, real estate brokers, realtors, real estate professionals, home inspectors, building inspectors, building officials, managers, business owners, consumers, companies, corporations, real estate management companies, renters, tenants, owners, sellers, rental property owners, rental property management companies, associations, real estate associations, government entities, administrators, etc. Further, the at least one remote server is used to manage the property reporting platform for the plurality of user accounts. The remote server can be managed through an administrator account by an administrator as seen in FIG. 1. The administrator who manages the remote server includes, but is not limited to, technician, engineer, system engineer, system specialist, software engineer, information technology (IT) engineer, IT professional, IT manager, IT consultant, service desk professional, service desk manager, consultant, manager, executive officer, chief operating officer, chief technology officer, chief executive officer, president, company, corporation, organization, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, cloud applications, and mobile applications compatible with a corresponding user PC device. Additionally, the software processes may store data into internal databases and communicate with external databases, which may include but are not limited to map databases (such as Google Maps®), DWS weather databases, National Oceanic and Atmospheric Administration (NOAA)/National Climatic Data Centre (NCDC) weather databases, NOAA/NCDC weather records, National Weather Service (NWS) weather records/databases, other suitable weather databases, hail databases, storm databases, wind databases, lightning databases, real estate databases, multiply listing service (MLS®) databases, real property databases, commercial property databases, databases maintaining data about geographical coordinates and addresses, etc. The interaction with external databases over a communication network may include, but is not limited to, the Internet.

As can be seen in FIG. 2, the overall process of the method of the present invention prompts the corresponding PC device of a specific user account to enter a property address through the remote server (Step B). More specifically, the method interacts with the PC device of the specific user account to receive a request of acquiring general and historical data of severe weather activities through the specification of a property address. The property is a real estate property, and may be, but is not limited to, residential real estate property, commercial real estate property, real estate property in an area with a defined address. The address of the property may be, but is not limited to, a physical address such as a home address, a geographical pair of latitude and longitude coordinates in a map system, etc. Subsequently, the method generates basic data of the specific property for the specific user account through the remote server (Step C). More specifically, the method uses the specified address of the property to search various databases, internal and/or external, for basic property data. The basic property data may include, but are not limited to, demographic and/or construction data, general weather data such as outdoor temperature, etc. Further, the method generates the historical data of at least one severe weather activity associated with the specific property for the specific user account through the remote server (Step D). More specifically, the method searches various weather-related database, internal and/or external, to acquire historical weather data for a predefined time period. The historical data for severe weather activity associated with the specific property may include, but is not limited to, hail, high wind/storm, lightning, etc. Further, the acquired weather data may or may not need specific processing before relaying to the specific user account. As both basic and historical data are being acquired and processed, the method reports the basic data and historical data of at least one severe weather activity associated with the specific property to the corresponding PC device of the specific user account through the remote server (Step E). The report that the present invention creates and sends to the specific user may include, but is not limited to, email report, text message report, data format report, detailed report with all available and processed data, a web page report, a mobile report, a digital link to a web page, etc.

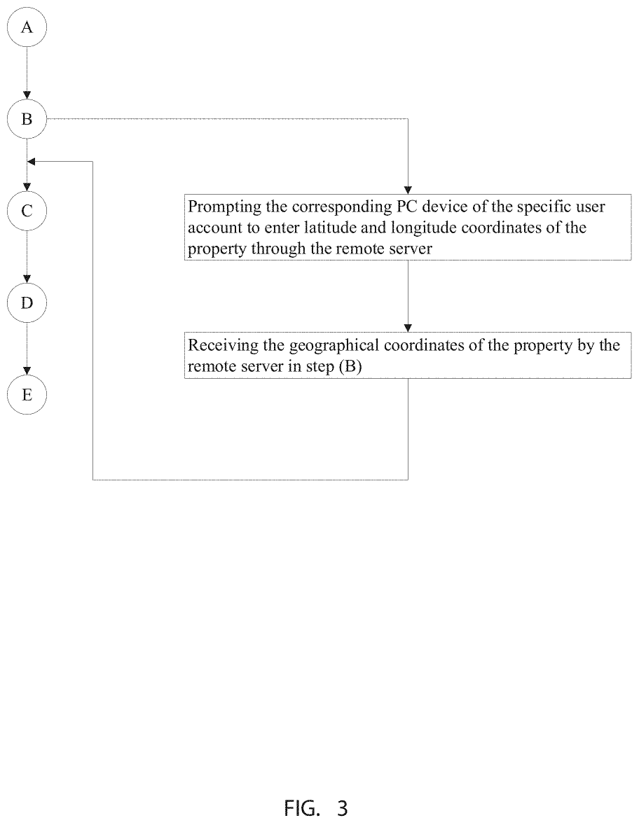

As can be seen in FIG. 3, the method of the present invention provides a sub-process to allow the specific user to enter geographic coordinates for the specific property. More specifically, the method prompts the corresponding PC device of the specific user account to enter latitude and longitude coordinates of the property through the remote server. Subsequently, the method receives the geographical coordinates of the property by the remote server in Step B. The user entered latitude and longitude coordinates of the property are then used in searches for basic and historical data of the specific property.

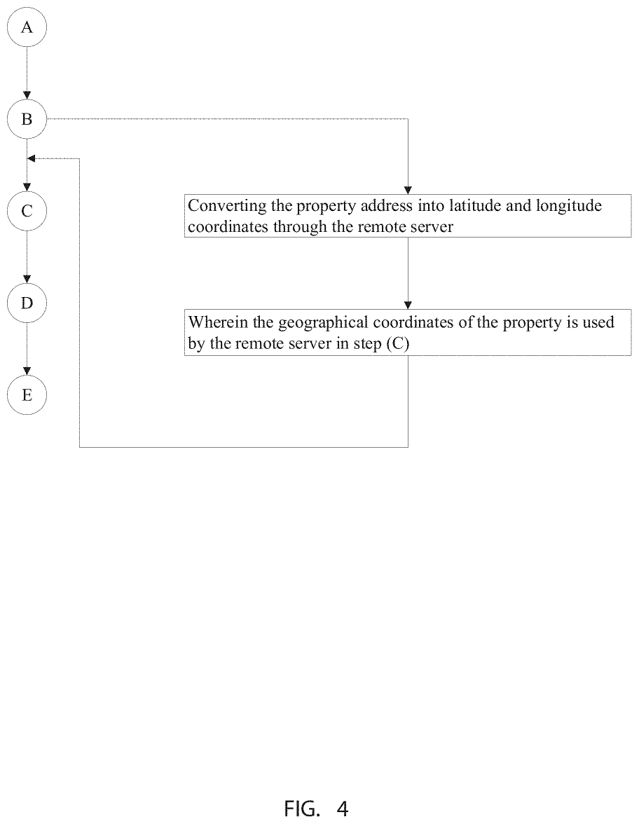

As can be seen in FIG. 4, the method of the present invention provides a sub-process to convert the address that the specific user entered into geographic coordinates for the specific property. More specifically, the method converts the property address into latitude and longitude coordinates through the remote server, wherein the geographical coordinates of the property are used by the remote server in Step B. The converted latitude and longitude coordinates of the property, either geographical distances or decimal degrees, are then used in searches for basic and historical data of the specific property.

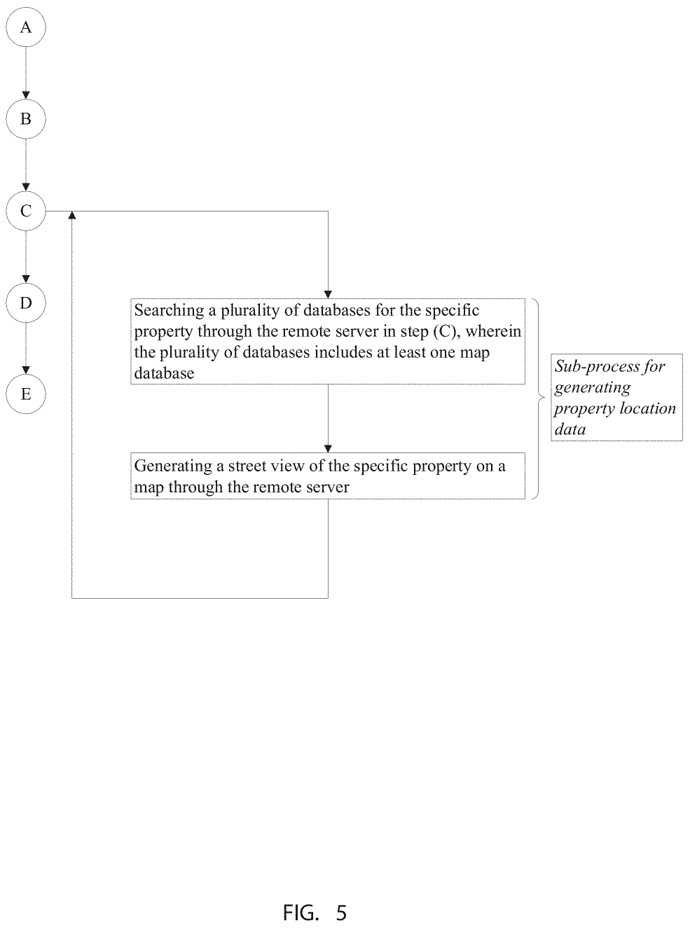

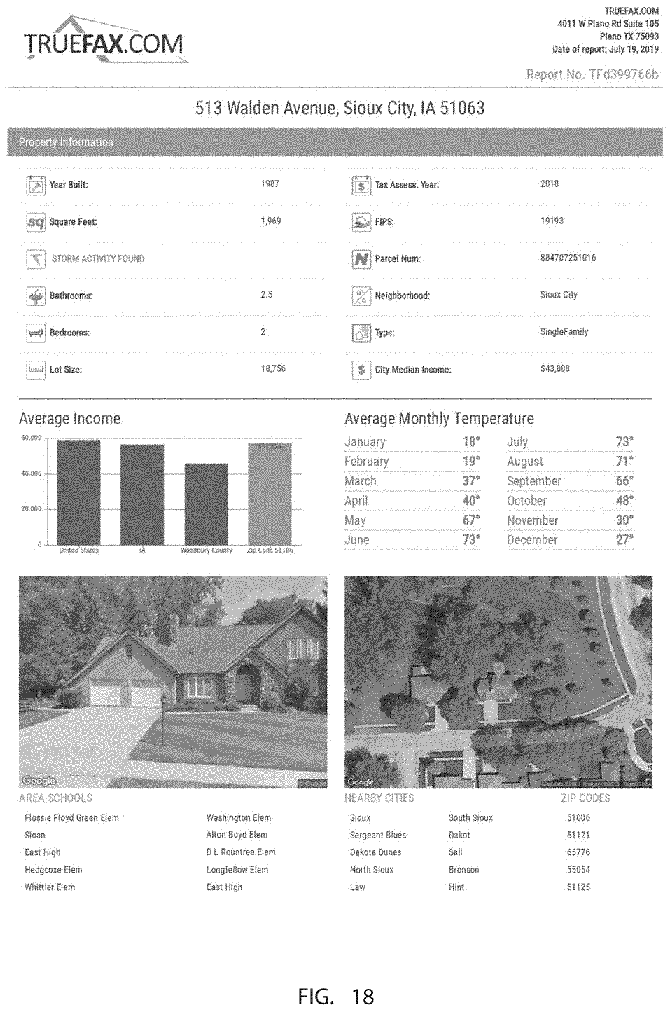

As can be seen in FIG. 5 and FIG. 18, the method of the present invention provides a sub-process for generating property location data. More specifically, the method searches a plurality of databases for the specific property through the remote server in Step C, wherein the plurality of databases includes at least one map database.

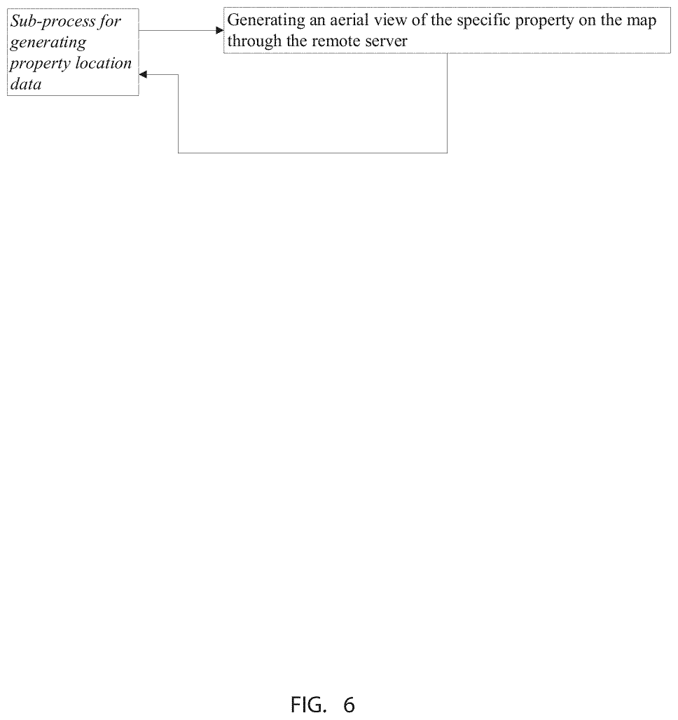

Subsequently, the method generates a street view of the specific property on a map through the remote server. The remote server may have a program including, but not limited to, Google® street view static API (application programming interface) that executes this specific sub-process. Using the latitude and longitude coordinates of the property, the method searches various internal and/or external databases for map data of the specific property. Additionally, the method may include, but is not limited to, a graphical presentation and/or a street view of the location of the specific property on a map, in additional to the physical address and/or geographical coordinates. In an alternative embodiment of the present invention, as can be seen in FIG. 6 and FIG. 18, the method generates an aerial view of the specific property on the map through the remote server. This aerial view is also called “bird's eye” view of the specific property on the map.

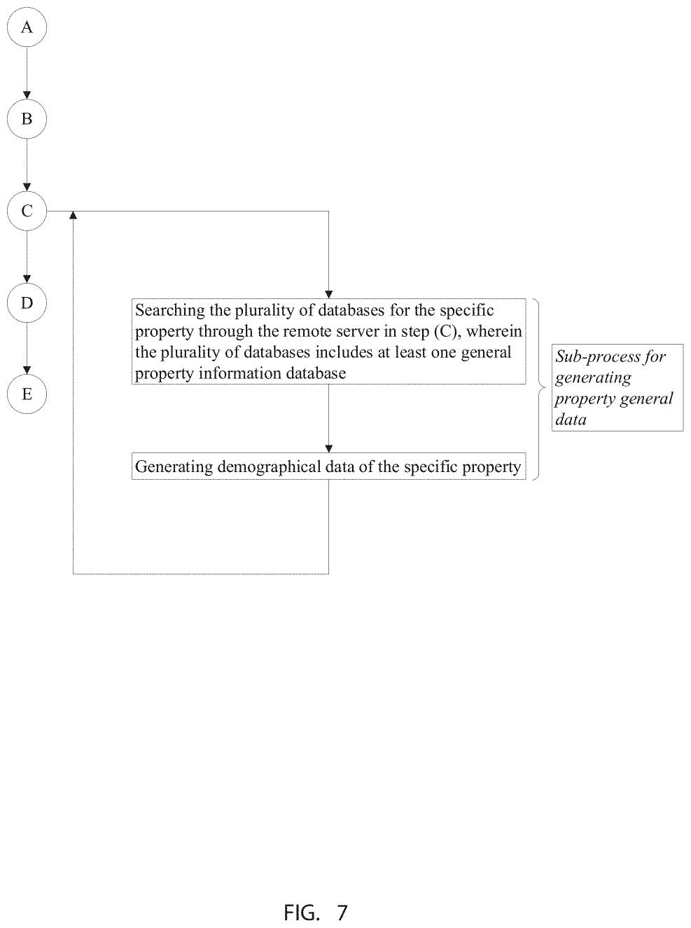

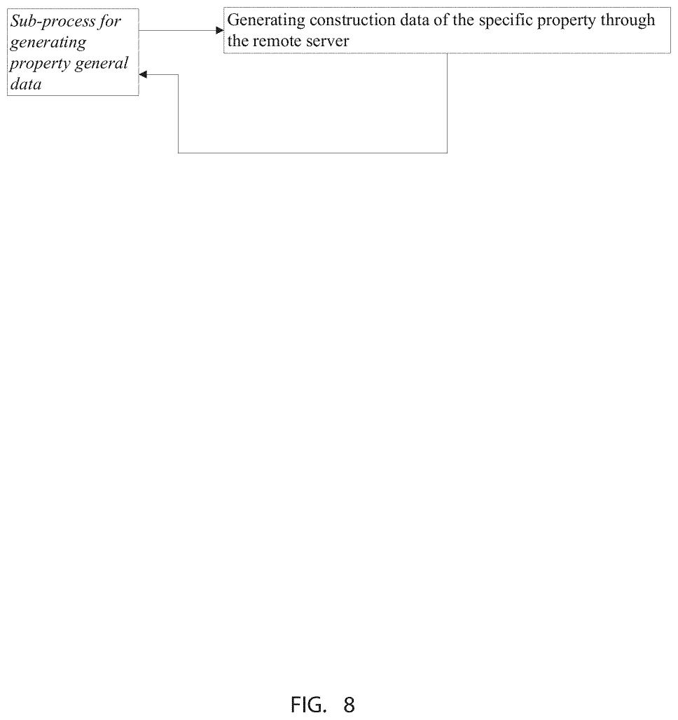

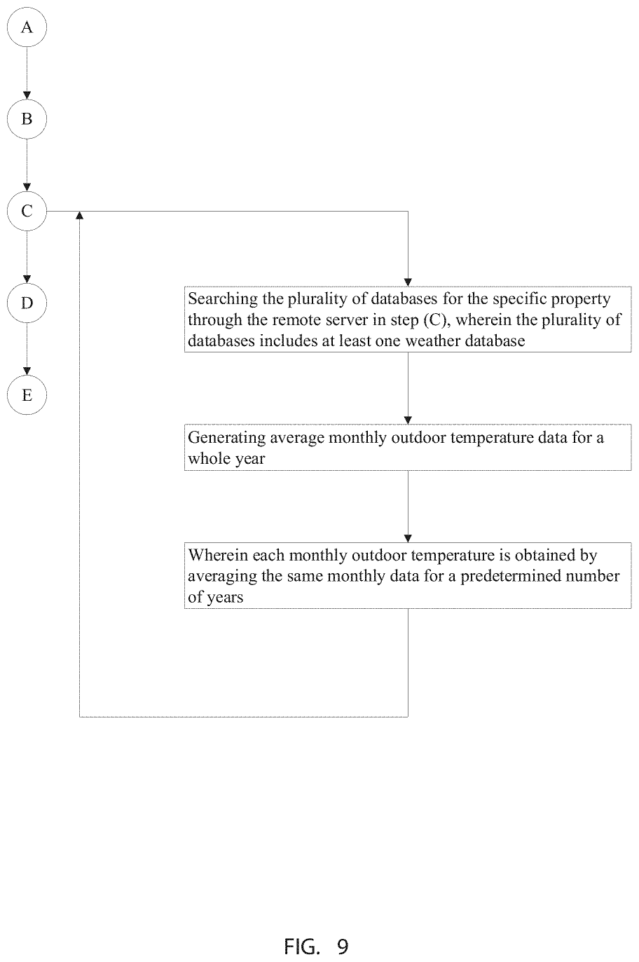

As can be seen in FIG. 7 and FIG. 18, the method of the present invention provides a sub-process for generating property general data. More specifically, the method searches the plurality of databases for the specific property through the remote server in Step C, wherein the plurality of databases includes at least one general property information database. Subsequently, the method generates demographical data of the specific property. The demographical data of the specific property may include, but are not limited to, physical locations such as street number, street name, city, state, zip code, community, municipal, township, county, neighborhood, nearby schools such as elementary school, middle school, high school, nearby cities, average household income in comparison with city average, and/or state average, country average, etc. In an alternative embodiment, as can be seen in FIG. 8 and FIG. 18, the method generates construction data of the specific property through the remote server. The construction data of the specific property may include, but is not limited to, year when the property was built, square feet, lot size in square feet or acres, type of property, number of stories, number of bedrooms, number of bathrooms, etc. In another embodiment of the present invention, as can be seen in FIG. 9 and FIG. 18, the method searches the plurality of databases for the specific property through the remote server in Step C, wherein the plurality of databases includes at least one weather database. Subsequently, the method generates average monthly outdoor temperature data for a whole year, wherein each monthly outdoor temperature is obtained by averaging the same monthly data for a predetermined number of years. The predetermined number of years may include, but is not limited to, a user specified number, a system default number such as five-year, 10-year, etc.

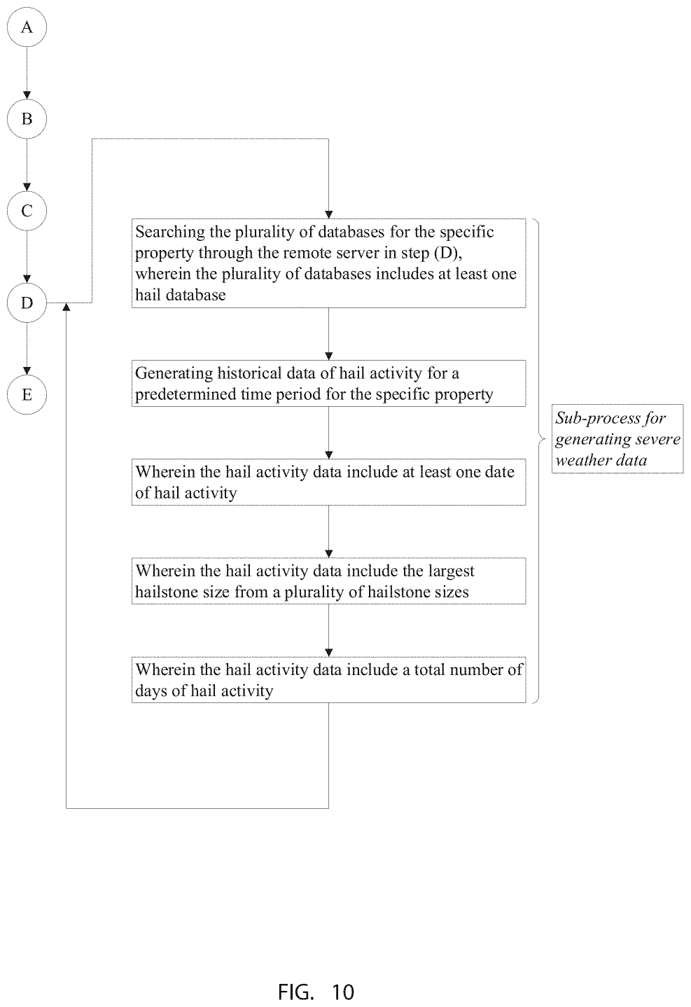

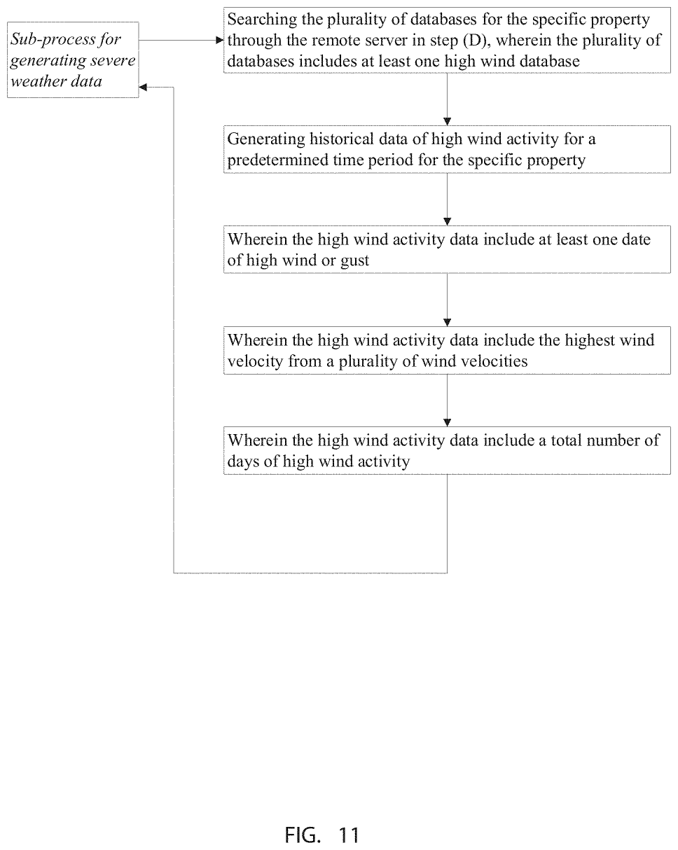

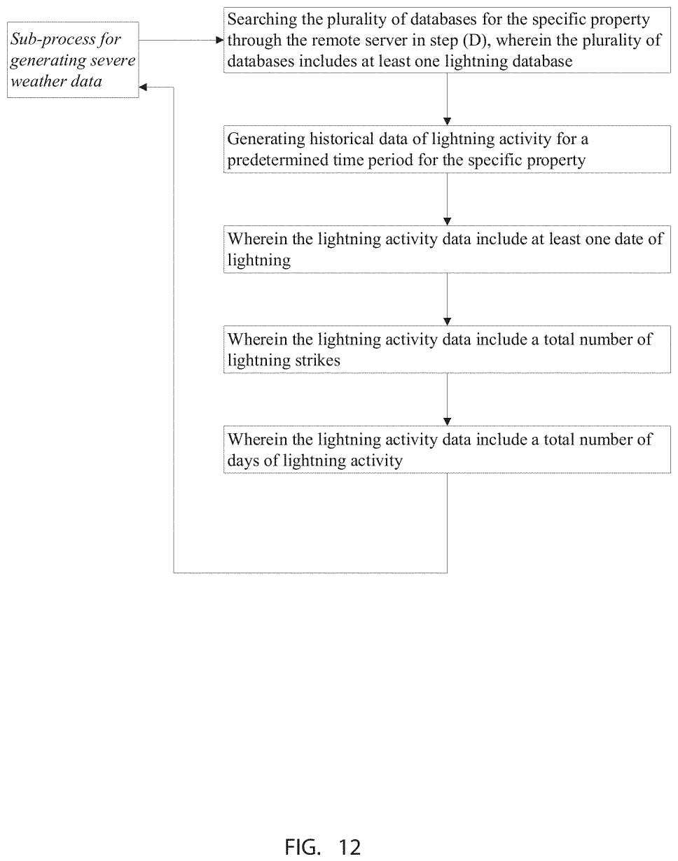

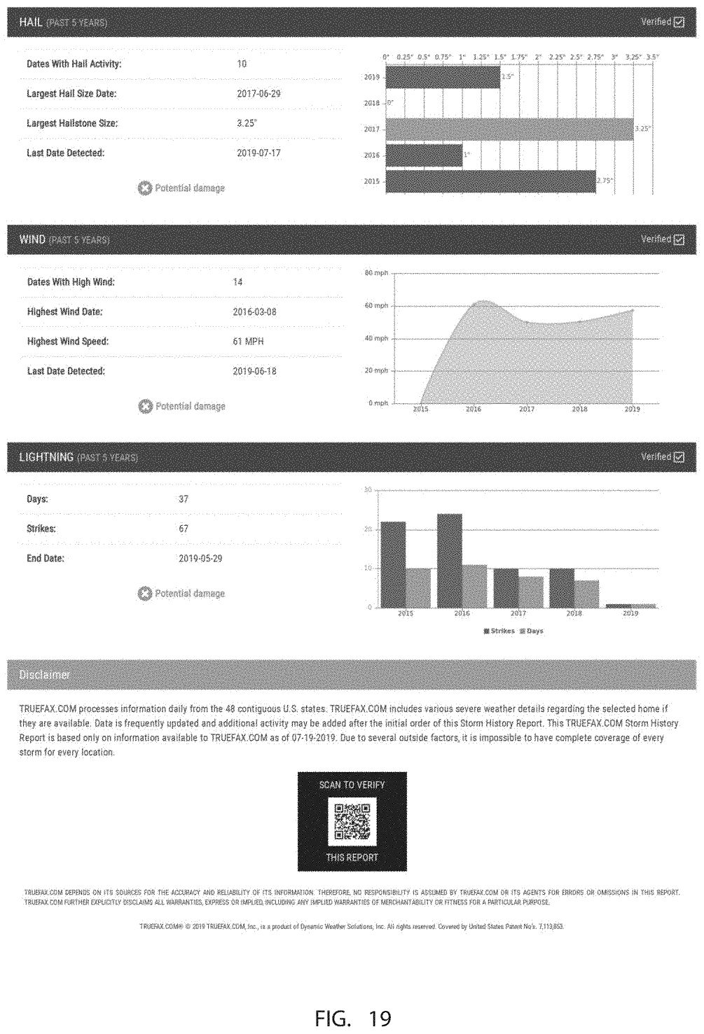

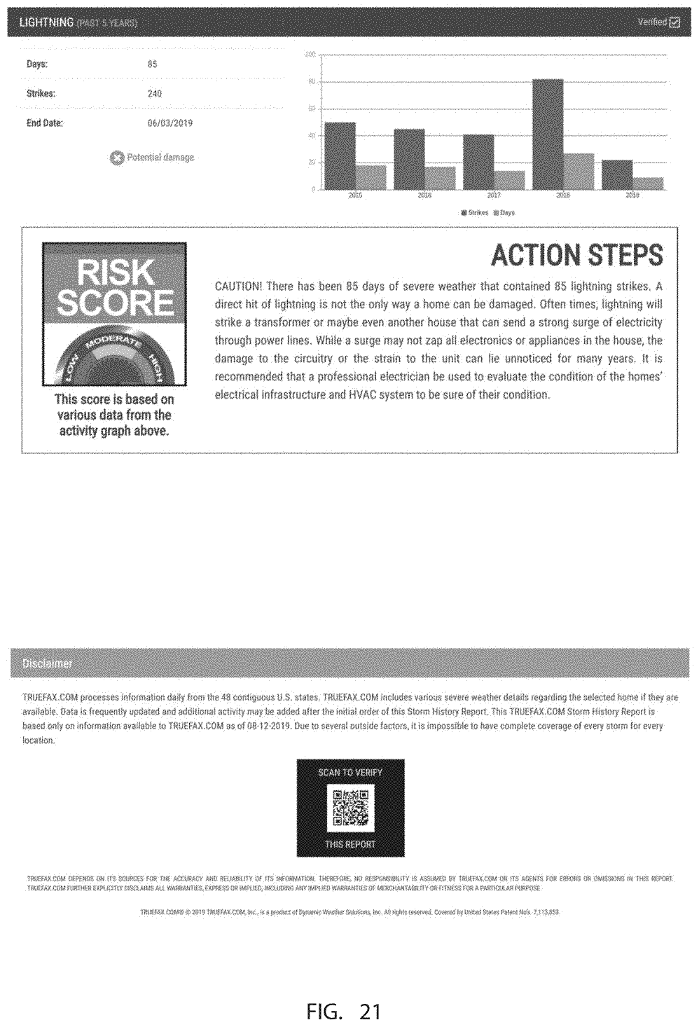

As can be seen in FIG. 10 and FIG. 19 to FIG. 20, the method of the present invention provides a sub-process for generating severe weather data for the specific property. More specifically, the method searches the plurality of databases for the specific property through the remote server in Step D, wherein the plurality of databases includes at least one hail database. Subsequently, the method generates historical data of hail activity for a predetermined time period for the specific property, wherein the hail activity data include at least one date of hail activity. Through further data processing, the method may provide additional historical data including, but not limited to, at least one date of hail activity, the largest hailstone size from a plurality of hailstone sizes, a total number of days of hail activity, etc. As aforementioned, the predetermined number of years may include, but is not limited to, a user specified number, a system default number such as five-year, 10-year, etc. As can be seen in FIG. 11 and FIG. 19 to FIG. 20, in an alternative embodiment of the present invention, the method searches the plurality of databases for the specific property through the remote server in Step D, wherein the plurality of databases includes at least one wind database. Subsequently, the method generates historical data of high wind activity for a predetermined time period for the specific property. Through further data processing, the method may provide additional historical data including, but not limited to, the highest wind velocity from a plurality of wind velocities, a total number of days of high wind activity, etc. As can be seen in FIG. 12, FIG. 19, and FIG. 21, in another embodiment of the present invention, the method searches the plurality of databases for the specific property through the remote server in Step D, wherein the plurality of databases includes at least one lightning database. Subsequently, the method generates historical data of high wind activity for a predetermined time period for the specific property. Through further data processing, the method may provide additional historical data including, but not limited to, at least one date of lightning, a total number of lightning strikes, a total number of days of lightning activity, etc.

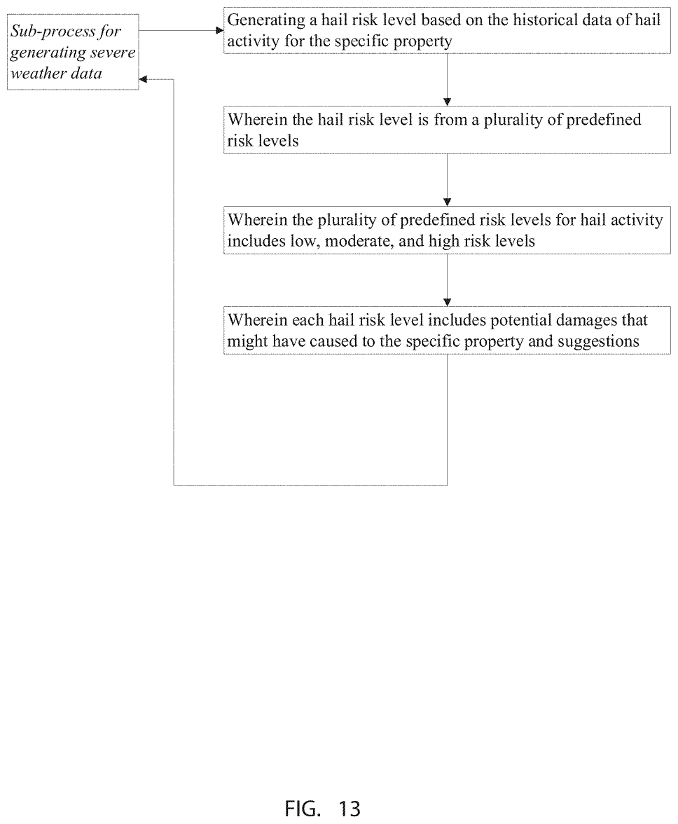

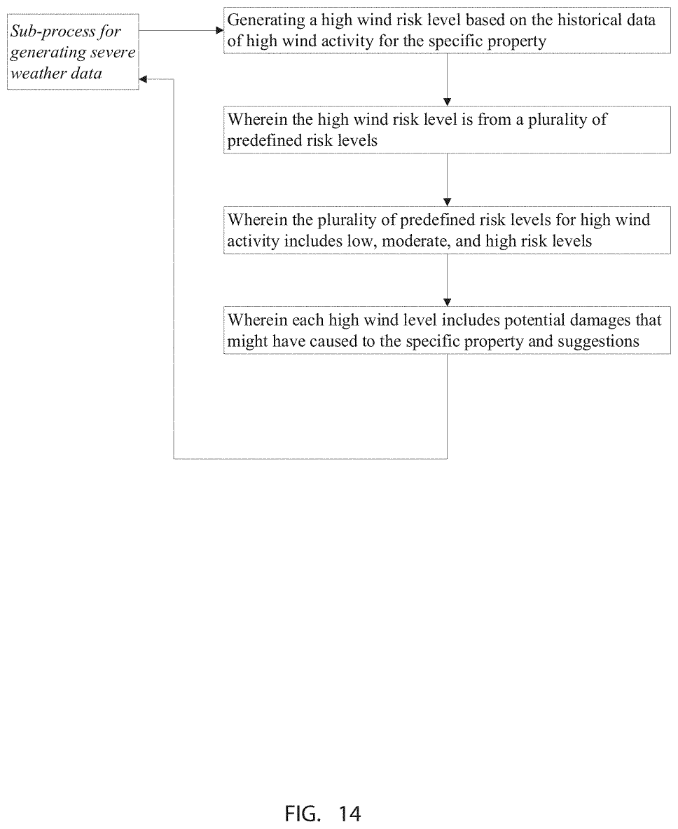

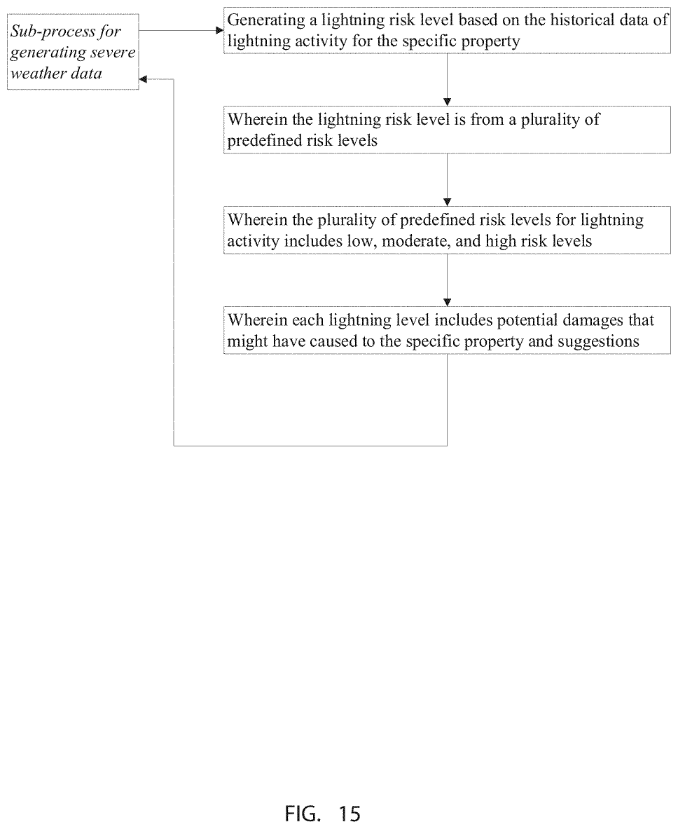

In another embodiment of the present invention, as can be seen in FIG. 13 and FIG. 19 to FIG. 20, the sub-process for generating severe weather data for the specific property provides at least one risk analysis associated with the historical data of severe weather activities for the specific property. More specifically, the method generates a hail risk level based on the historical data of hail activity for the specific property, wherein the hail risk level is from a plurality of predefined risk levels. Additionally, the plurality of predefined risk levels for hail activity includes varying levels including, but not limited to, low, moderate, and high risk levels, wherein each hail risk level includes potential damages that might have been causing to the specific property and suggestions. Based on the potential damages to the specific property, the method further offers suggestions and recommendations for risk mediation actions. In another embodiment of the present invention, as can be seen in FIG. 14 and FIG. 19 to FIG. 20, the method generates a high wind risk level based on the historical data of high wind activity for the specific property, wherein the high wind risk level is from a plurality of predefined risk levels. Additionally, the plurality of predefined risk levels for high wind activity includes varying levels including, but not limited to, low, moderate, and high risk levels, wherein each high wind level includes potential damages that might have caused to the specific property and suggestions. In another embodiment of the present invention, as can be seen in FIG. 15, FIG. 19, and FIG. 21, the method generates a lightning risk level based on the historical data of lightning activity for the specific property, wherein the lightning risk level is from a plurality of predefined risk levels. Additionally, the plurality of predefined risk levels for lightning activity includes varying levels including, but not limited to, low, moderate, and high risk levels, wherein each lightning level includes potential damages that might have caused to the specific property and suggestions.

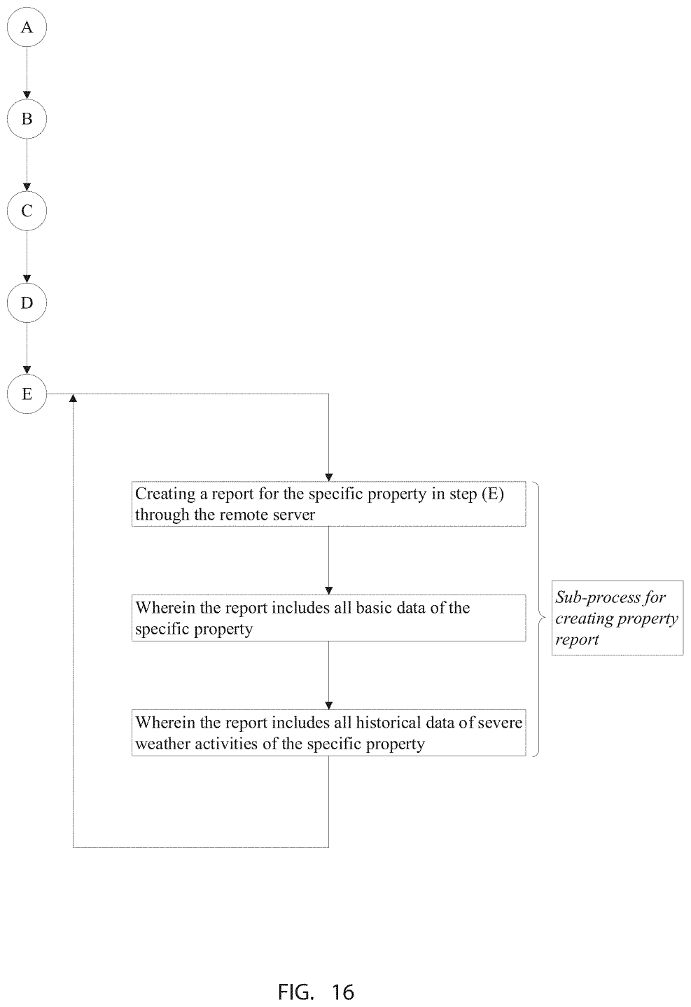

As can be seen in FIG. 16 and FIG. 18 to FIG. 21, the method of the present invention provides a sub-process for creating property report for the specific property. More specifically, the method creates a report for the specific property in Step E through the remote server, wherein the report includes all basic data of the specific property, and wherein the report includes all historical data of severe weather activities of the specific property.

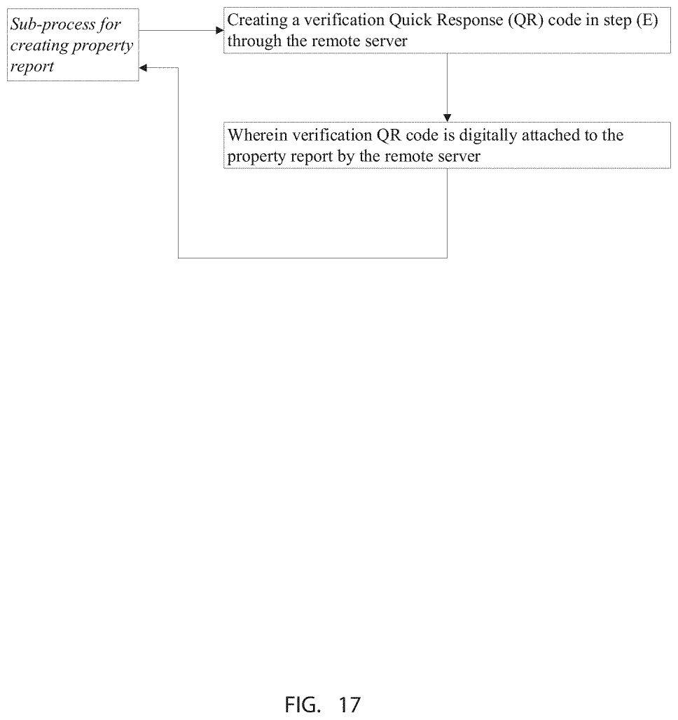

In an alternative embodiment of the present invention, as can be seen in FIG. 17, FIG. 18 to FIG. 19, and FIG. 21, the method creates a verification Quick Response (QR) code in step (E) through the remote server, wherein the verification QR code is digitally attached to the property report by the remote server. The verification QR code is used to verify the credibility of the report for the specific property. Additionally, the method may offer property reports in digital formats including, but not limited to, Adobe® PDF (portable digital format), any other suitable format. Further, the method makes a report available through online access, download, or a notification electronic mail (email) that is sent to the specific user with an included Adobe® PDF report.

Although the invention has been explained in relation to its preferred embodiment, it is to be understood that many other possible modifications and variations can be made without departing from the spirit and scope of the invention as hereinafter claimed.

What is claimed is:

1. A method and system for providing real property historical data of severe weather activities comprising the steps of:
(A) providing a plurality of user accounts managed by at least one remote server, wherein each of the plurality of user accounts is associated with a corresponding personal computing (PC) device;
(B) prompting the corresponding PC device of a specific user account to enter a property address through the remote server;
(C) generating basic data of the specific property for the specific user account through the remote server;
(D) generating the historical data of at least one severe weather activity associated with the specific property for the specific user account through the remote server; and
(E) reporting the basic data and historical data of at least one severe weather activity associated with the specific property to the corresponding PC device of the specific user account through the remote server.

2. The method and system for providing real property historical data of severe weather activities as claimed in claim 1, wherein the real property includes residential real estate properties.

3. The method and system for providing real property historical data of severe weather activities as claimed in claim 1, wherein the real property includes commercial real estate properties.

4. The method and system for providing real property historical data of severe weather activities as claimed in claim 1, wherein the real property includes a real estate property in an area with a defined address.

5. The method and system for providing real property historical data of severe weather activities as claimed in claim 1 comprising the steps of:
prompting the corresponding PC device of the specific user account to enter latitude and longitude coordinates of the property through the remote server; and
receiving the geographical coordinates of the property by the remote server in step (B).

6. The method and system for providing real property historical data of severe weather activities as claimed in claim 1 comprising the steps of:
converting the property address into geographical latitude and longitude coordinates through the remote server; and
wherein the geographical coordinates of the property are used by the remote server in step (C).

7. The method and system for providing real property historical data of severe weather activities as claimed in claim 1 comprising the steps of:
searching a plurality of databases for the specific property through the remote server in step (C), wherein the plurality of databases includes at least one map database; and
generating a street view of the specific property on a map through the remote server.

8. The method and system for providing real property historical data of severe weather activities as claimed in claim 7 comprising the steps of:
generating an aerial view of the specific property on the map through the remote server.

9. The method and system for providing real property historical data of severe weather activities as claimed in claim 1 comprising the steps of:
searching the plurality of databases for the specific property through the remote server in step (C), wherein the plurality of databases includes at least one general property information database; and
generating demographical data of the specific property.

10. The method and system for providing real property historical data of severe weather activities as claimed in claim 9 comprising the steps of:
generating construction data of the specific property through the remote server.

11. The method and system for providing real property historical data of severe weather activities as claimed in claim 1 comprising the steps of:
searching the plurality of databases for the specific property through the remote server in step (C), wherein the plurality of databases includes at least one weather database;
generating average monthly outdoor temperature data for a whole year; and
wherein each monthly outdoor temperature is obtained by averaging the same monthly data for a predetermined number of years.

12. The method and system for providing real property historical data of severe weather activities as claimed in claim 1 comprising the steps of:
searching the plurality of databases for the specific property through the remote server in step (D), wherein the plurality of databases includes at least one hail database;
generating historical data of hail activity for a predetermined time period for the specific property;
wherein the hail activity data include at least one date of hail activity;
wherein the hail activity data include the largest hailstone size from a plurality of hailstone sizes; and
wherein the hail activity data include a total number of days of hail activity.

13. The method and system for providing real property historical data of severe weather activities as claimed in claim 1 comprising the steps of:
searching the plurality of databases for the specific property through the remote server in step (D), wherein the plurality of databases includes at least one wind database;
generating historical data of high wind activity for a predetermined time period for the specific property;
wherein the high wind activity data include at least one date of high wind or gust;
wherein the high wind activity data include the highest wind velocity from a plurality of wind velocities; and
wherein the high wind activity data include a total number of days of high wind activity.

14. The method and system for providing real property historical data of severe weather activities as claimed in claim 1 comprising the steps of:
searching the plurality of databases for the specific property through the remote server in step (D), wherein the plurality of databases includes at least one lightning database;
generating historical data of lightning activity for a predetermined time period for the specific property;
wherein the lightning activity data include at least one date of lightning;
wherein the lightning activity data include a total number of lightning strikes; and
wherein the lightning activity data include a total number of days of lightning activity.

15. The method and system for providing real property historical data of severe weather activities as claimed in claim 12 comprising the steps of:
generating a hail risk level based on the historical data of hail activity for the specific property;
wherein the hail risk level is from a plurality of predefined risk levels;
wherein the plurality of predefined risk levels for hail activity includes varying risk levels; and
wherein each hail risk level includes potential damages that might have caused to the specific property and suggestions.

16. The method and system for providing real property historical data of severe weather activities as claimed in claim 13 comprising the steps of:
generating a high wind risk level based on the historical data of high wind activity for the specific property;
wherein the high wind risk level is from a plurality of predefined risk levels;
wherein the plurality of predefined risk levels for high wind activity includes varying risk levels; and
wherein each high wind level includes potential damages that might have caused to the specific property and suggestions.

17. The method and system for providing real property historical data of severe weather activities as claimed in claim 14 comprising the steps of:
generating a lightning risk level based on the historical data of lightning activity for the specific property;
wherein the lightning risk level is from a plurality of predefined risk levels;
wherein the plurality of predefined risk levels for lightning activity includes varying risk levels; and
wherein each lightning level includes potential damages that might have caused to the specific property and suggestions.

18. The method and system for providing real property historical data of severe weather activities as claimed in claim 1 comprising the steps of:
creating a report for the specific property in step (E) through the remote server;
wherein the report includes all basic data of the specific property; and
wherein the report includes all historical data of severe weather activities of the specific property.

19. The method and system for providing real property historical data of severe weather activities as claimed in claim 1 comprising the steps of:
creating a verification Quick Response (QR) code in step (E) through the remote server; and
wherein verification QR code is digitally attached to the property report by the remote server.
